(19) United States
(12) Patent Application Publication
(10) Pub. No.: US 2002/0060773 A1
(43) Pub. Date: May 23, 2002

(54) Peeling device for polarizing film

(75) Inventor: Shih Yang Lee, Kaohsiung (TW)

Correspondence Address: LOWE HAUPTMAN GILMAN & BERNER, LLP, 1700 Diagonal Road, Suite 310, Alexandria, VA, 22314, US

(73) Assignee: HannStar Display Corp.

(21) Appl. No.: 09/990,285

(22) Filed: Nov. 23, 2001

(30) Foreign Application Priority Data
Nov. 23, 2000 (TW) 89125096

(51) Int. Cl. G02F 1/13

(52) U.S. Cl. 349/187

(57) ABSTRACT

A peeling device comprises a frame, two support rollers and a take-up roller pivotally connected to the frame, and a driving device mounted on the frame for driving the take-up roller rotating relative to the frame. The axis of the take-up roller is parallel to the two support roller. When the driving device drives the take-up roller rotating relative to the frame, the polarizing film will be wound on the take-up roller till the polarizing film is completely peeled out of the LCD panel. It should be noted that one of the two support rollers is positioned between the take-up roller and the other of the two support rollers, and therefore the LCD panel is loaded on two support rollers and the take-up roller dose not apply force to the LCD panel. The present invention further provides a method for peeling the polarizing film from the LCD panel by means of the peeling device according to the present invention.

### BACKGROUND OF THE INVENTION

1. Field of the Invention

The present invention generally relates to a peeling device, and more particularly to a peeling device for polarizing film used in manufacturing liquid crystal displays and the method for peeling the polarizing film from a liquid crystal display panel.

2. Description of the Related Art

With advantages of miniaturizing computer, real-time processing of operation and image, enlarging capacity of memory, increasing speed of data transmission and the like, new requirements from customer are generated, such as miniaturizing monitor of the computer for fitting a limited space, displaying and identifying of the image of the security system, and displays having little radiating and harmless features. The above mentioned requirements can be met by making use of the liquid crystal display (LCD) as the interface between humans and machines. By the way, the LCDs still have the advantage of low power consumption, saving energy, portability, high resolution, and continue displaying, and thus the LCD will be an ideal and desired product in the 21 st century.

Basically, any kind of the LCD panel calls for two polarizing films for transforming natural light into polarized light, whereby the LCD can utilize the polarized light and the twist features of liquid crystal molecules under electrical field to control the polarized light to pass through or rotate a certain angle to generate display of different text and image.

Generally, the LCD undergoes many stages of fabrication and testing before the product is completed. It is not unusual to damage or scratch the polarizing film on the LCD panel in the subsequent manufacturing processes. Accordingly, the damaged or scratched polarizing film must be removed and replaced with another film. Further, the polarizing film may also be damaged during general use and thus the polarizing film must be removed in the repair process.

FIG. 1 illustrates a conventional tool 100 to remove a sheet of polarizing film from an LCD. Firstly, a corner of the polarizing film 10 is separated from the LCD panel 20 by a knife, and the corner is adhered to a roller 120 with a tape 110. The LCD panel is pressed with a plate (not shown), and the roller 120 is rotated by hand to peel the polarizing film. It should be noted that, in the process of peeling the polarizing film, the pressure applied to the LCD panel needs to be uniform, or the so called “mura effect” will be generated to destroy the LCD panel. Further, since the roller 120 presses the LCD panel 20 via the polarizing film 10, the roller 120 must be operated by skillful operators for ensuring that the roller is rotated at a uniform speed. Further, the conventional tool 100 is rotated by hand, and thus the LCD panel might be broken by improper pressure.

In order to overcome the drawbacks of the conventional tools, U.S. Pat. No. 5,891,297 discloses a hand-rotation peeling device 200 (as shown in FIGS. 2 and 3), which generally includes two support rollers 210 and a take-up roller 220 disposed therebetween. The hand-rotation peeling device 200 is still operated by hand to rotate a crank 230 and then drive the take-up roller 220, so the roller 220 must still be operated by skillful operators for ensuring that the roller is rotated at a uniform speed. Now referring to FIG. 2, the LCD panel 20 is carried by the right support roller 210 and the take-up roller 220. If the rotating speed of the roller is slight changed, the pressure loaded on the LCD panel 20 may be un-uniform and the mura effect may be generated. Now referring to FIG. 3, although the LCD panel 20 is mainly carried by the two support rollers 210 at this time, the take-up roller 220 still contacts the LCD panel 20 through the polarizing film 10. During the peeling process of the polarizing film 10, even if the rollers are rotated at a constant speed, the polarizing film 10 wound round the takeup roller 220 also varies the pressure loaded on LCD panel 20 and the mura effect may be generated such that the LCD panel will be destroyed.

Therefore, there exist needs for providing a peeling device for polarizing film to overcome the above mentioned problems.

### SUMMARY OF THE INVENTION

It is a primary object of the present invention to provide a peeling device for polarizing film in which the pressure loaded on the LCD panel can be kept uniform during peeling the polarizing film, thereby increasing the yield of the product.

It is another object of the present invention to provide a method for peeling the polarizing film on the LCD panel, in which the method utilizes the peeling device for polarizing film that is easy to learn and substantially reduces the risk of failure.

The peeling device for peeling polarizing film according to the present invention is used for peeling polarizing films from the LCD panels, and mainly comprises a frame, two support rollers and a take-up roller pivotally connected to the frame, and a driving device mounted on the frame for driving the take-up roller to rotate with respect to the frame. The axis of the take-up roller is parallel to those of the two support rollers. When the driving device rotates the take-up roller with respect to the frame, the polarizing film will be wound on the take-up roller till the polarizing film is completely peeled out of the LCD panel. It should be noted that one of the two support rollers is positioned between the take-up roller and the other of the two support rollers, and therefore the LCD panel is supported by the two support rollers and the take-up roller dose not apply any force to the LCD panel.

Since the take-up roller of the peeling device is driven by a driving device, the rotation of the rollers can be operated at a uniform speed without requiring skillful operators.

The present invention further provides a method for peeling the polarizing film from the LCD panel by the peeling device according to the present invention, and the method comprises the following steps of: (a) peeling a corner of the polarizing film from the LCD panel; (b) adhering an end of a tape to the peeled corner of the polarizing film; (c) adhering the other end of the tape to the take-up roller through the gap between the two support rollers; and (d) actuating a driving device to rotate the take-up roller with respect to the frame in a first direction such that the polarizing film is wound on the take-up roller till the polarizing film is completely peeled from the LCD panel. Since the LCD panel can be supported by the two support rollers and the take-up roller dose not apply force to the LCD panel, the pressure loaded on the LCD panel can be kept uniform, thereby increasing the yield of the product.

### BRIEF DESCRIPTION OF THE DRAWING

Other objects, advantages, and novel features of the invention will become more apparent from the following detailed description when taken in conjunction with the accompanying drawings.

FIG. 1 is a side cross-sectional view of the conventional tool for peeling a polarizing film adhered to the LCD panel.

FIGS. 2 and 3 are side plan views of the known hand-rotation peeling device for peeling a polarizing film from the LCD panel.

FIGS. 4 and 5 are perspective views of a peeling device of a preferred embodiment according to the present invention for peeling a polarizing film from the LCD panel.

FIG. 6 is an enlarged front plan view of the control box of the peeling device of the preferred embodiment according to the present invention.

FIG. 7 is side plan views of the peeling device of the preferred embodiment according to the present invention which is used for peeling a polarizing film from the LCD panel.

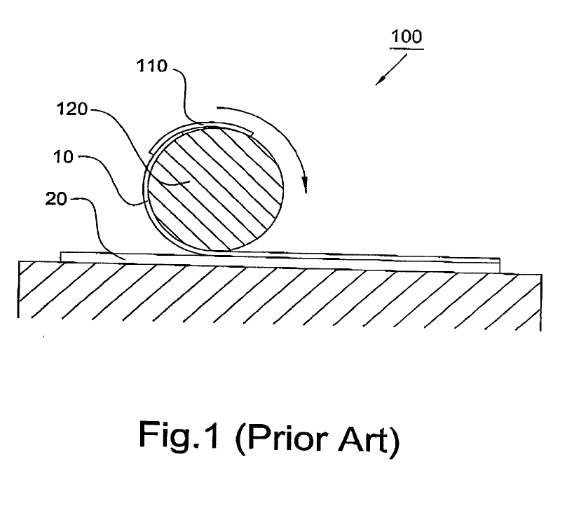

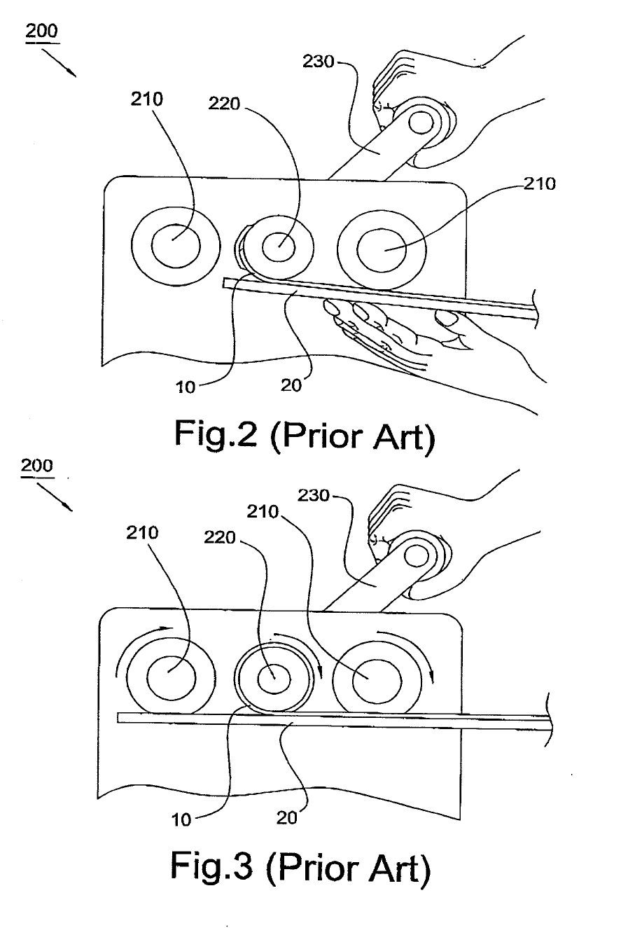

### DETAILED DESCRIPTION OF THE PREFERRED EMBODIMENT

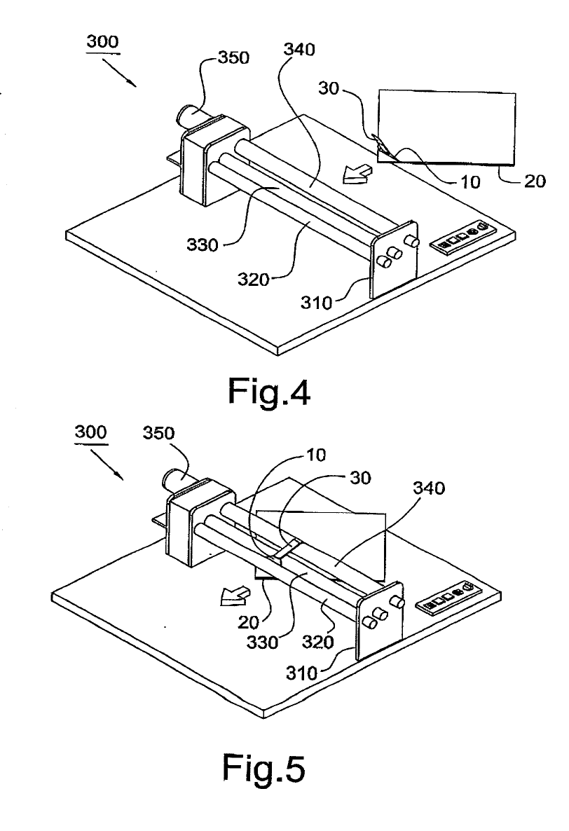

As shown in FIG. 4, it depicts a power drive peeling device 300 according to preferred embodiment for peeling a polarizing film, and the peeling device 300 generally includes a frame 310, two support rollers 320, 330 and a take-up roller 340 respectively pivotally connected to the frame 310, and a motor 350 mounted on the frame 310 for driving the take-up roller 340 rotating relative to the frame 310. The axes of the two support rollers 320, 330 are parallel to each other and there is a gap between the two support rollers 320, 330 that is bigger than the thickness of the polarizing film to be peeled. In one preferable embodiment, if the thickness of the polarizing film that needs to be peeled is 0.8 mm, the gap between the two rollers 310, 320 is preferably at least 1.8 mm. Besides, the axis of the take-up roller 340 is parallel to the two support rollers 320, 330. It should be noted that the support roller 330 is positioned between the take-up roller 340 and the other support roller 320. It should be understood that the motor 350 is an electric motor, a hydraulic motor or a pneumatic motor. However, in order to achieve the objects of the present invention, the motor for driving the take-up roller rotating relative to the frame 310 is provided by way of example but not limitation, other suitable drive devices, such as pneumatic or hydraulic cylinder, can be used for driving the take-up roller rotating relative to the frame 310.

The peeling device according to the present invention is preferably provided with a set of transmission gears for connecting the motor 350 to the take-up roller 340. The peeling device according to the present invention is provided with a control box 360 (as shown in FIG. 7) that is used to control the actuation and operation of the peeling device. The rotation of the rollers of the peeling device according to the present invention can be operated at a uniform speed without requiring skillful operators, because the take-up roller 340 is driven by means of the motor 350.

The present invention further provides a method for peeling the polarizing film from the LCD panel by means of the peeling device according to the present invention.

Referring to FIG. 4, a blade (not shown) is provided for peeling a corner of the polarizing film from the LCD panel, and then an end of a tape 30 adheres to the peeled corner of the polarizing film. It should be understood that the tape 30 and the adhered corner of the polarizing film is further adhered together by means of another tape 32 (referring to FIG. 7).

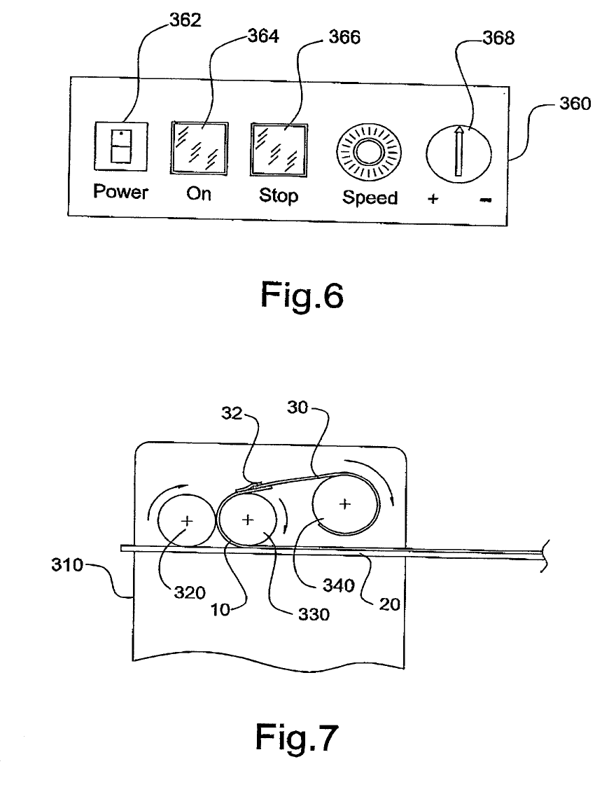

Referring FIGS. 5, 6 and 7, the other end of the tape 30 is passed through the gap between the two support rollers 320, 330, and adheres to the take-up roller 340. It should be noted that the axes of the two rollers 320, 330 is offset in vertical direction, and the offset distance is generally equal to the thickness of the polarizing film such that the LCD panel 20 can be substantially kept in the horizontal direction.

Subsequently, the rotation of the motor is set in clockwise direction by means of a switch 368, and then an electric power 362 is turned on and an actuating button 364 is pressed, while the motor 350 will start to drive the take-up roller 340 rotating relative to the flame 310. It should be noted that the LCD panel 20 is completely supported on the two support rollers 320, 330 (certainly, the panel 20 can be still held by hands when the panel 20 is too heavy). Since the peeled corner of the polarizing film is adhered on the take-up roller 340 by the tape, the polarizing film 10 will be wound on the take-up roller 340 till the polarizing film 10 is completely peeled and a stop button 366 is pressed. It should be noted that the take-up roller 340 dose not contact the LCD panel 20 neither directly nor indirectly during the entirely peeling process of the polarizing film, and therefore the polarizing film 10 wound on the take-up roller 340 will not completely influence the pressure loaded on the LCD panel 20. Finally, the rotation of the motor is set in reverse direction by means of the switch 368, and then the electric power 362 is turned on and the actuating button 364 is pressed, while the motor 350 will drive the take-up roller 340 rotating it in reverse direction and the polarizing film wound on the take-up roller 340 can be took out.

Since peeling device for peeling the polarizing film according to the present invention allows the LCD panel to be supported on the two support rollers from the beginning and the motor can drive the take-up roller 340 at a uniform speed, the pressure loaded on the LCD panel can be kept uniform, thereby increasing the yield of the product.

Although the invention has been explained in relation to its preferred embodiment, it is to be understood that many other possible modifications and variations can be made without departing from the spirit and scope of the invention as hereinafter claimed.

What is claimed is:

1. A peeling device for peeling a polarizing film on an LCD panel, the peeling device comprising:
a frame;
a first and a second support rollers pivotally connected to the frame, parallel to each other, and defining a gap therebetween;
a take-up roller pivotally connected to the frame, the rotating axis thereof being parallel to the two support rollers, and the first support roller being positioned between the take-up roller and the second support roller; and
a driving device mounted on the frame for driving the take-up roller rotating relative to the frame,
wherein when the driving device drives the take-up roller rotating relative to the frame, the polarizing film will be wound on the take-up roller till the polarizing film is completely peeled out of the LCD panel, and the LCD panel is loaded on two support rollers and the take-up roller dose not apply force to the LCD panel.

2. The peeling device as claimed in claim 1, wherein the driving device is a motor drive device.

3. The peeling device as claimed in claim 1, wherein the driving device is a hydraulic drive device.

4. The peeling device as claimed in claim 1, wherein the driving device is a pneumatic drive device.

5. The peeling device as claimed in claim 1, further comprising a transmission gear set for connecting the driving device to the take-up roller.

6. The peeling device as claimed in claim 1, wherein the first and the second support rollers are offset in vertical direction, the offset distance substantially equals to the thickness of the polarizing film such that the LCD panel can be substantially kept in the horizontal direction.

7. A method for peeling a polarizing film from an LCD panel, which using a peeling device which comprises a frame, a first and a second support rollers pivotally connected to the frame, parallel to each other, and defining a gap therebetween, a take-up roller pivotally connected to the frame, the rotating axis thereof being parallel to the two support rollers each other, and the first support roller being positioned between the take-up roller and the second support roller, and a driving device mounted on the frame for driving the take-up roller rotating relative to the frame, the method comprising the steps of:
peeling a corner of the polarizing film from the LCD panel;
adhering an end of a tape to the peeled corner of the polarizing film;
adhering the other end of the tape to the take-up roller through the gap between the two support rollers; and
actuating the driving device to rotate the take-up roller relative to the frame in a first direction such that the polarizing film is wound on the take-up roller till the polarizing film is completely peeled from the LCD panel,
wherein the LCD panel is supported on the two support rollers and the take-up roller dose not force to the LCD panel.

8. The method as claimed in claim 7, further comprising the steps of:
rotating the take-up roller in a second direction opposite to the first direction to take out the polarizing film wound on the take-up roller.
